(19) United States
(12) Patent Application Publication
(10) Pub. No.: US 2011/0140384 A1
(43) Pub. Date: Jun. 16, 2011

(54) FOOT PROPELLED SCOOTER

(76) Inventor: Dennis Seargeant, Thunder Bay (CA)

(21) Appl. No.: 11/691,622

(22) Filed: Mar. 27, 2007

Related U.S. Application Data
(60) Provisional application No. 60/787,151, filed on Mar. 30, 2006.

(51) Int. Cl. B62M 1/00

(52) U.S. Cl. 280/87.041

(57) ABSTRACT

A foot propelled scooter includes a board having arranged to receive the feet of a rider placed on the board with one foot in advance of the other along the board and a wider section at the center than at the ends. A pair of wheels is located underneath the board across the center for supporting the board in rolling movement over a surface. A hand grip member is fixed to the board and stands upwardly from the board at one end and at the other end is provided an additional wheel mounted for steering movement by a foot engaging member which projects longitudinally outwardly from one end of the board with a foot pad with upstanding side walls for receiving and locating the foot. In another version, there are three wheels arranged along the center with a middle one of the wheels lower than the others. The board can be separated into two wheeled sections each for a respective foot of the rider.

This application claims priority under 35 U.S.C. 119 from U.S. Provisional Application Ser. No. 60/787,151 filed Mar. 20, 2006.

This invention relates to a foot propelled scooter.

### SUMMARY OF THE INVENTION

It is one object of the invention to provide a novel arrangement of scooter for transportation and fun by a rider.

According to one aspect of the invention there is provided a foot propelled scooter comprising:

a board having first and second ends and side edges shaped and arranged to receive the feet of a rider placed on the board with one foot in advance of the other along the board;

at least one main wheel located underneath the board for supporting the board in rolling movement over a surface;

said at least one main wheel being located at a position thereon spaced from the ends of the board;

and a hand grip member fixed to the board and standing upwardly from the board for grasping by a hand of the rider at a position on the board spaced toward one end of the board from said at least one main wheel.

Preferably the hand grip member includes a transverse handle bar at a top end.

Preferably there is provided at least one additional wheel at a position on the board spaced from said at least one main wheel toward one end of the board.

Preferably the additional wheel is adjacent an end of the board opposite to the hand grip member.

Preferably the additional wheel is mounted for steering movement about an upstanding steering axis and there is provided a foot engaging member by which the rider can effect said steering movement.

Preferably the foot engaging member by which the rider can effect said steering movement projects longitudinally outwardly from one end of the board and connects directly to a bracket supporting the additional wheel for turning the additional wheel about the steering axis.

Preferably the foot engaging member includes a foot pad with upstanding side walls for receiving and locating the foot.

In one embodiment the main wheel includes a pair of wheels spaced side by side across the board. In this arrangement, preferably the board is wider at a center section where the pair of wheels are located than at the ends.

The hand grip member may include a brake lever for actuating a brake on the scooter and may activate a brake on the main wheel actuable by the rider.

In an alternative arrangement, the at least one main wheel comprises a single wheel and there is provided at least one additional wheel in line with the main wheel and having a bottom surface above the bottom surface of the main wheel such that the board can roll on the main wheel with the additional wheel raised from the surface.

In this arrangement, preferably there is a front additional wheel forwardly of the main wheel and a rear additional wheel behind the main wheel.

In an another alternative, the board may be separable at a location along its length into a front part and a rear part where each foot is located on a respective one of the parts and each part includes at least one wheel. The parts may include a latch operable by the rider to connect and release the parts while riding.

According to a second aspect of the invention there is provided a foot propelled scooter comprising:

a board having first and second ends and side edges shaped and arranged to receive the feet of a rider placed on the board with one foot in advance of the other along the board;

at least one main wheel located underneath the board for supporting the board in rolling movement over a surface;

said at least one main wheel being located at a position thereon spaced from the ends of the board;

at least one additional wheel at a position on the board spaced from said at least one main wheel toward one end of the board;

wherein the at least one additional wheel is mounted for steering movement about an upstanding steering axis and wherein there is provided a foot engaging member by which the rider can effect said steering movement.

According to a second aspect of the invention there is provided a foot propelled scooter comprising:

a board shaped and arranged to receive the feet of a rider with one foot in advance of the other along the board;

wherein the board is separable at a location along its length into a front part and a rear part where each foot is located on a respective one of the parts;

a main wheel located underneath the front part of the board for supporting the board in rolling movement over a surface;

the main wheel being located generally centrally of the board such that the rider can balance the board on the single main wheel while moving over the surface;

and an additional wheel on the rear part for movement of the rear part over the surface when separated from the front part.

### BRIEF DESCRIPTION OF THE DRAWINGS

One embodiment of the invention will now be described in conjunction with the accompanying drawings in which;

FIG. 1 is a side elevational view of a first embodiment of the scooter according to the present invention.

FIG. 2 is a top plan view of the scooter of FIG. 1.

FIG. 3 is a side elevational view of a second embodiment of the scooter according to the present invention.

FIG. 4 is a top plan view of the scooter of FIG. 3.

FIG. 5 is a side elevational view of a first embodiment of the scooter according to the present invention.

FIG. 6 is a top plan view of the scooter of FIG. 5.

In the drawings like characters of reference indicate corresponding parts in the different figures.

### DETAILED DESCRIPTION

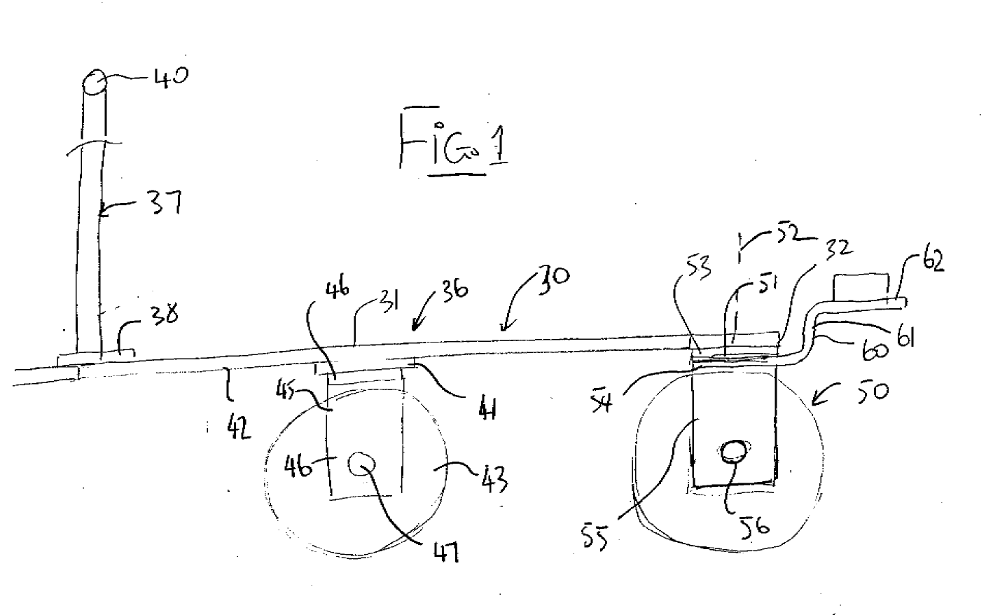

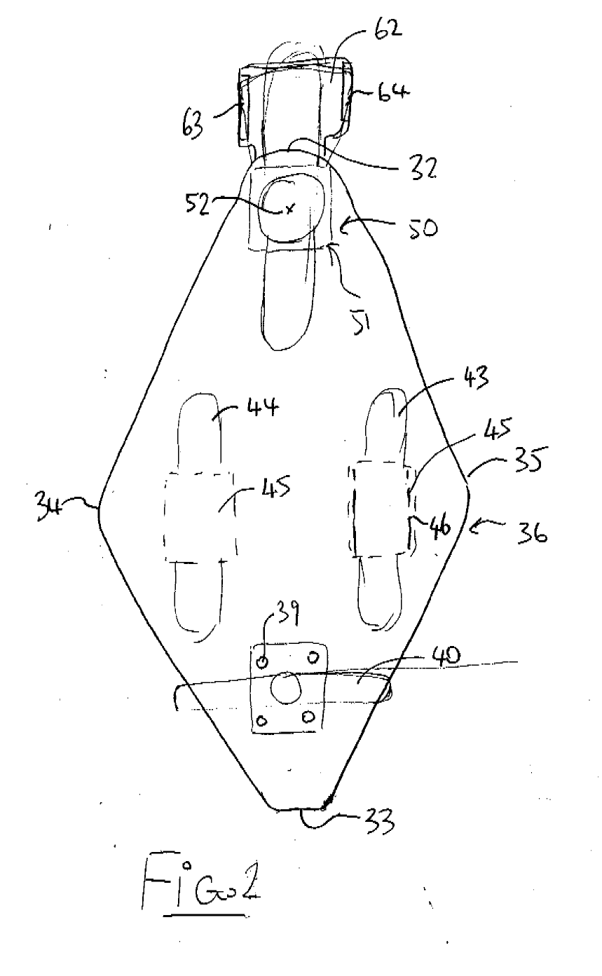

In FIGS. 1 and 2 is shown a first embodiment of a scooter according to the present invention. This arrangement comprises a board generally indicated at 30 which is a generally flat board having an upper surface 31 on which the rider can stand. The length of the board is generally greater than the width of the board so that the rider can stand with one foot in advance of the other in the manner of a snowboard. The upper surface may include hold down elements into which the feet are engaged similar to a snowboard or may simply be open for the rider to stand in the manner of a skate board.

The board has ends 32 and 33 and sides 34 and 36. The length is greater than the width and the width between the sides increases at a center section generally indicated at 36 and tapers toward the ends 32 and 33. Thus the board in plan is generally of a diamond shape although the ends may be blunted and the sides may have straight sections at the central area 36.

The board may be formed from any suitable material such as simple plywood or more engineered composite materials to provide sufficient strength to enable it to be ridden in the manner in accordance with the structure set out hereinafter.

At the end 33 is provided a fixed upstanding handle grip member generally indicated at 37 which is attached onto the top surface 31 by a base 38 fastened to the base for example by screws 39. The hand grip member provides no steering action in the sense that it has no connection with any steering axle or any wheel and is simply fixed to the board so as to stand upwardly from the board to provide hand grasp portion at the upper end allowing the rider to grasp the portion and provide stability between the rider and the board. For this purpose the hand grip portion includes a transverse handle bar 40. The hand grip is arranged close to the end 33. In the central area 36, the board has a transverse stiffening plate 41 across the bottom surface 42. Attached to this stiffening plate 41 is provided a pair of wheels 43 and 44 each carried on a support bracket 45. The support brackets 45 include an upper horizontal plate 46 which bolts to the stiffening plate 41 together with a pair of depending side legs 46 each on a respective side of the wheel and providing support for an axle 47 of the wheel. The wheels are thus arranged on a common axis coaxial with the two axles 47 across the width of the board. The axis is arranged to be generally aligned at the center section 36 which is at the wider part of the board providing sufficient space for the two wheels and allowing the two wheels to be spaced apart to provide stability for the board in the side to side direction. The wheels are arranged close to but spaced inwardly from the side edges.

At the forward end is provided a further wheel generally indicated at 50. This is carried on a steering bracket 51 which allows the wheel 50 to be rotated about an upright front steering axis 52 defined by the steering bracket 51. Thus the steering bracket 51 comprises a base plate 53 attached to the underside of the board closely adjacent the front end 32 together with a swivelling plate 54 attached to the mounting plate 53 by suitable bearings (not shown) which allow the plate 54 to swivel about the axis 52 on the plate 53. The plate 54 carries a pair of depending side legs 55 which support an axle 56 of the wheel 50. The wheels 43, 44 and 50 are approximately the same size so that the board is supported in a horizontal orientation on the three separate wheels. The steering plate 54 includes a forward projection portion 60 which extends from the plate upwardly and forwardly at an angle portion 61 to form a foot pad 62 presented at the front 32 of the board and at a height slightly above the board. The foot pad 62 includes a pair of upstanding side edges 63 and 64 so as to define an area between the side edges on which the foot of the rider can be placed with the foot being constrained between the sides 63 and 64 and the foot being located in front of the front edge 32 of the board.

Thus the rider can place the heel of the foot on the front end of the board and the toe of the foot into the foot pad 62 allowing the rider to twist the ankle turning the foot to left or right to provide a steering action on the wheel 50.

The upstanding hand grip portion is of course at the opposite end from the additional steering wheel 50 allowing the main weight of the rider to be placed in the center section over the center wheels or main wheels 44 and 43. The rider can thus present the other foot which carries less weight forwardly to the forward end of the board for engaging the foot pad portion to provide the steering action while applying some weight to the hand grip portion, The steering action is a dual steering action in that both leaning of the weight of the rider to one side together with the slight twisting of the foot provides a turning of the board in a curve toward the intended direction. The hand grip portion allows the rider to transfer the leaning action into a slight inclination of the board to the left or right as required as the steering by the foot is applied.

The wheels may be solid but more preferably have rubber tires to provide some resilience. Suspension may be provided but more preferably the wheels are directly attached by fixed brackets to the underside of the board so that the only suspension effect is provided by the resilience in the tires.

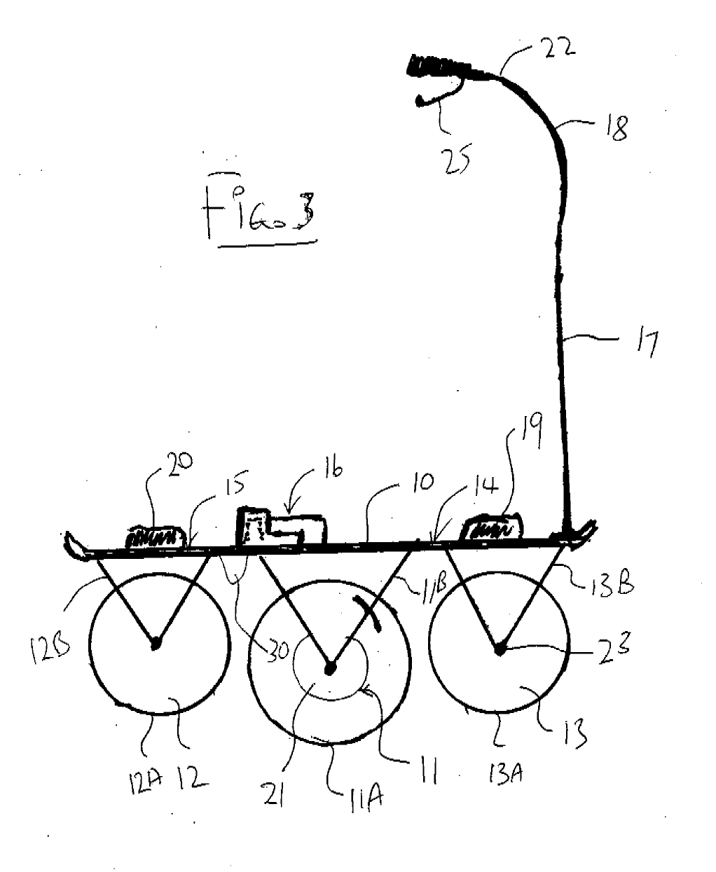

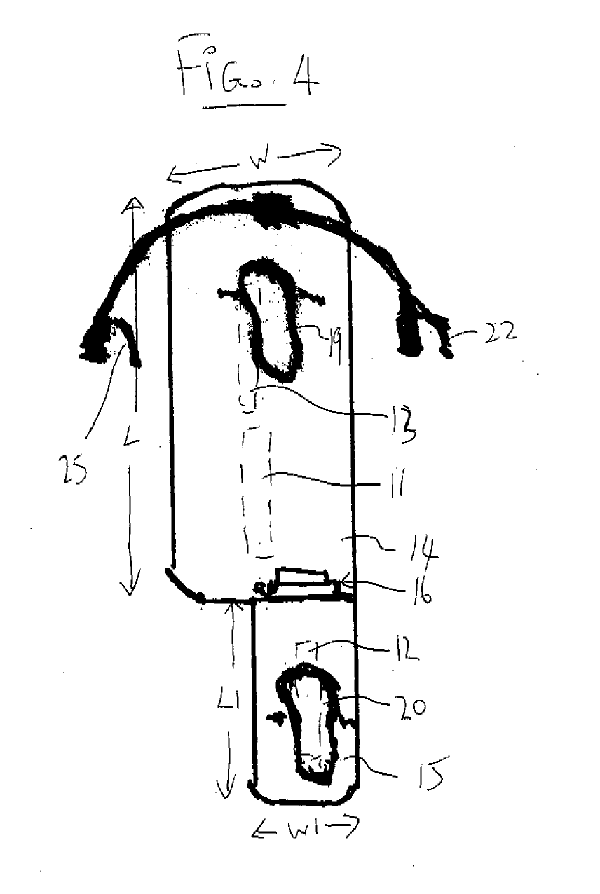

In FIGS. 3 and 4 is shown a second embodiment of the invention which includes a board 10 carrying three wheels 11, 12 and 13. In this embodiment the board is divided into a front section 14 and a rear section 15 connected at a latching arrangement 16. The main wheel 11 is located substantially centrally of the board and has a peripheral edge at the bottom as indicated at 11A which is below the bottom edges of the wheels 12 as indicated at 12A and the wheel 13 as indicated at 13A. Thus when balanced the board can rest solely upon the main wheel 11 with the wheels 12 and 13 raised from the ground. However slight forward or rearward tilting of the board acts to apply to the rear wheel or the front wheel respectively to the ground so as to provide a more stable rolling action with both wheels on the ground.

At one end of the board is provided an upstanding post 17 which forms a hand grip member. In the embodiment shown at the top of the post is provided a handlebar 18 which extends across the post in a plane parallel to the board and at right angles to the post. For convenience of illustration, FIG. 1 shows the handle bar in isometric view. The post is shown attached to the front of the board but can be attached at any suitable location but the intention is that the hand grip member defined by the post and the handle bar stands upwardly from the board in front of the rider when the rider is standing on the board. The front portion 14 of the board includes a front foot receptacle 19 and the rear portion 15 of the board includes a rear foot receptacle 20. These can be simply straps across the board where the user places the foot underneath the strap so as to be held in place by pressure of the strap against the upper surface of the board. In the alternative the receptacles may give a more complex nature including a toe section which engages over the toe of the rider and a heel section which pushes the foot into the toe section so that the foot is held more vigorously on the board. In a yet further alternative, the board may include attached boots into which the unshod foot of the wearer is inserted. Such boots are similar to those used in skates so that the board is in effect attached to the foot of the wearer without possibility of the foot being removed.

As shown in FIG. 4 the wheels 11, 12 and 13 are attached longitudinally of the board so as to roll along the length of the board. The wheels 11 and 13 are arranged in line that is with the wheel 13 directly in front of the wheel 11. The wheel 12 is offset to one side since it is central of the rear portion 15 of the board.

The wheel 11 is mounted on a bracket 11B and carries a brake 21 which operates between the bracket 11B and the wheel so as to effect a braking action. The brake is actuated by a brake lever 22 carried on one end of the handle bar 18.

The wheels 12 and 13 are mounted by brackets 12B and 13B. The brackets 11B, 12B and 13B can be of any suitable construction including simply triangular plates carrying the lower end across axle 23 or maybe formed of lightweight struts so as to reduce the weight of the device. The brackets are suitably attached at the upper end to the under side of the board.

As shown in FIG. 4 the front portion 14 of the board is wider at width W than a width W1 of the rear portion 15. In addition the front portion is longer as indicated at a length L than is the length of the rear portion as indicated at L1. The length of the board is suitably selected so that a user of a certain height can place one foot in the holder 19 and a second foot in the holder 20 and comfortably stand with one leg in front of the other on the board in this manner.

The latch 16 is actuated by a lever 25 on the other end of the handle bar so that the latch can be opened to release the rear portion from the front portion and also to reattach the rear portion to the front portion.

While the board portions are shown as different sizes with the front portion significantly wider and longer than the rear portion, this is not necessarily so and the portions may be of the same width. The height of the handle bar is selected such that the person for which the size is determined can suitably stand on the board and hold the handle bar. The handle bar does not in any way steer the structure by turning all of the wheels and all of the wheels are fixed in arrangement longitudinally of the board and do not turn relative to the board. In the intended manner of operation of the board, the rider places the feet in the required locations and operates the latch to separate the two portions 14 and 15. With the portions so separated and attached to the feet, the rider can act in a skating motion to push forwardly. When sufficient speed has been obtained by the pushing action using the skating motion, the foot attached to the rear portion is brought up behind the foot attached to the front portion so as to bring a tongue of the latch into engagement with a latch receptacle on the front portion and the two portions are latched together in fixed position. In fixed position the two portions are coplanar and are prevented from bending about a transverse axis so as to form in effect a stiff board. In this position, the rider can then simply ride in the manner of a conventional scooter in the longitudinal direction of the board. The rider can balance the board on the center main wheel 11 thus reducing rolling friction. Alternatively, the rider can choose to tilt the board slightly forwardly or rearwardly so it rolls on two wheels. However the steering action is effected by balancing the board on one wheel and by tilting the board using the leverage action by pulling on the feet and by the handle bar so as to twist the board about the point of contact between the main wheel 11 and the ground. The latch 16 includes side stops which can be formed from angle brackets so as to locate the rear portion to one side and prevent it moving side to side. In the arrangement shown in FIG. 4, the rear portion is offset to the right hand side so that's side edges collinear with the right hand side of the board portion 14. This leaves a space behind the main portion at the left hand side. The board can also be set up so as to mount the rear portion to the left either with a second latch or as an alternative structure depending upon the requirements of the rider. As shown in FIG. 3, there is a rubber joint protector 30 in front of the front edge of the board and behind the latch.

The latch comprises a lip on the front end of the rear board section which snaps over a receptacle on the rear of the front board portion and is held in place by the latch mechanism which can be released by a latch cable. The latch mechanism must operate simply and easily so as to allow the rider to quickly bring the rear portion into engagement with the rear of the front portion.

The wheels preferably carry rubber tires.

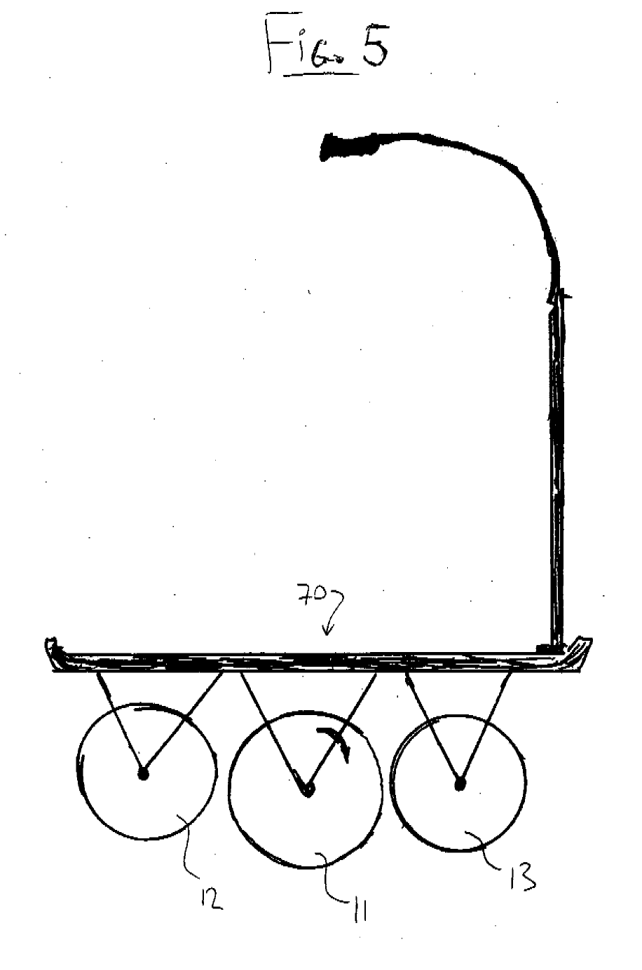

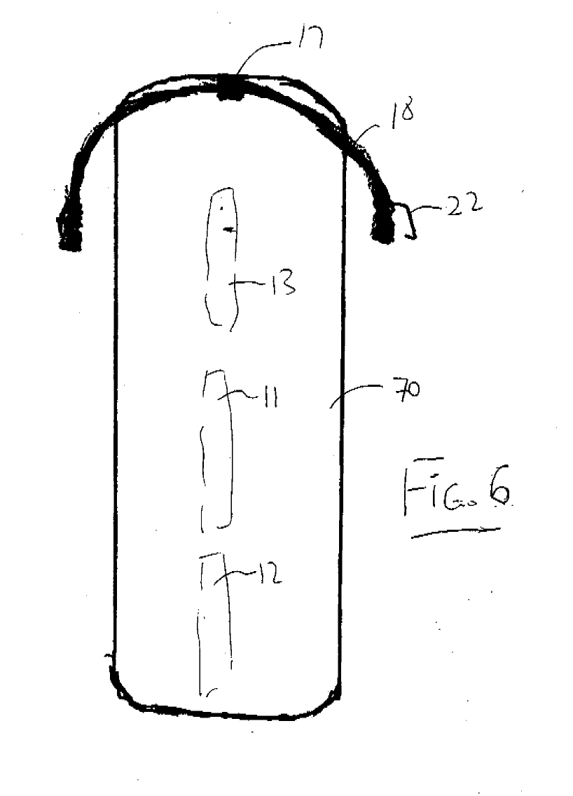

In FIGS. 5 and 6 is shown an alternative arrangement in which the board is formed as a single element with all of the wheels 11, 12 and 13 attached to the underside of the single board 7-. Again there is a post 17 and handle bar 18 but in this case there is a single lever 22 acting on the brake for the wheel 11. In this embodiment there is no necessity for the feet to be attached to the board so that the board is simply a flat upper surface on which the rider can stand. However foot receptacles can be provided if preferred.

In the second embodiment the back adjoining board, which is used in a skating motion to build speed before being connected, may have one wheel as shown or may have two wheels, in which case they may be of similar size or the front wheel a little smaller but still smaller than the wheel of the main board. The rear board portion may or may not have a brake system.

A motor may be provided for driving the main wheel or wheels.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A foot propelled scooter comprising:
a board having first and second ends and side edges shaped and arranged to receive the feet of a rider placed on the board with one foot in advance of the other along the board;
at least one main wheel located underneath the board for supporting the board in rolling movement over a surface;
said at least one main wheel being located at a position thereon spaced from the ends of the board;
and a hand grip member fixed to the board and standing upwardly from the board for grasping by a hand of the rider at a position on the board spaced toward one end of the board from said at least one main wheel.

2. The scooter according to claim 1 wherein the hand grip member includes a transverse handle bar at a top end.

3. The scooter according to claim 1 wherein there is provided at least one additional wheel at a position on the board spaced from said at least one main wheel toward one end of the board.

4. The scooter according to claim 3 wherein the at least one additional wheel is adjacent an end of the board opposite to the hand grip member.

5. The scooter according to claim 3 wherein the at least one additional wheel is mounted for steering movement about an upstanding steering axis and wherein there is provided a foot engaging member by which the rider can effect said steering movement,

6. The scooter according to claim 5 wherein the foot engaging member by which the rider can effect said steering movement projects longitudinally outwardly from one end of the board and connects directly to a bracket supporting the additional wheel for turning the additional wheel about the steering axis.

7. The scooter according to claim 5 wherein the foot engaging member includes a foot pad with upstanding side walls for receiving and locating the foot.

8. The scooter according to claim 1 wherein the at least one main wheel comprises a pair of wheels spaced side by side across the board.

9. The scooter according to claim 8 wherein the board is wider at a center section where the pair of wheels are located than at the ends.

10. The scooter according to claim 1 wherein the hand grip member includes brake lever for actuating a brake on the scooter.

11. The scooter according to claim 1 wherein the at least one main wheel includes a brake actuable by the rider.

12. The scooter according to claim 1 wherein the at least one main wheel comprises a single wheel and there is provided at least one additional wheel in line with the main wheel and having a bottom surface above the bottom surface of the main wheel such that the board can roll on the main wheel with the additional wheel raised from the surface.

13. The scooter according to claim 12 wherein there is a front additional wheel forwardly of the main wheel and a rear additional wheel behind the main wheel.

14. The scooter according to claim 1 wherein the board is separable at a location along its length into a front part and a rear part where each foot is located on a respective one of the parts and each part includes at least one wheel.

15. The scooter according to claim 14 wherein the parts include a latch operable by the rider to connect and release the parts while riding.

16. A foot propelled scooter comprising:
a board having first and second ends and side edges shaped and arranged to receive the feet of a rider placed on the board with one foot in advance of the other along the board;
at least one main wheel located underneath the board for supporting the board in rolling movement over a surface;
said at least one main wheel being located at a position thereon spaced from the ends of the board;
at least one additional wheel at a position on the board spaced from said at least one main wheel toward one end of the board;
wherein the at least one additional wheel is mounted for steering movement about an upstanding steering axis and wherein there is provided a foot engaging member by which the rider can effect said steering movement.

17. The scooter according to claim 16 wherein the foot engaging member by which the rider can effect said steering movement projects longitudinally outwardly from one end of the board and connects directly to a bracket supporting the additional wheel for turning the additional wheel about the steering axis.

18. The scooter according to claim 16 wherein the foot engaging member includes a foot pad with upstanding side walls for receiving and locating the foot.

19. The scooter according to claim 16 wherein the at least one main wheel comprises a pair of wheels spaced side by side across the board.

20. The scooter according to claim 19 wherein the board is wider at a center section where the pair of wheels are located than at the ends.

21. A foot propelled scooter comprising;
a board shaped and arranged to receive the feet of a rider with one foot in advance of the other along the board;
wherein the board is separable at a location along its length into a front part and a rear part where each foot is located on a respective one of the parts;
a main wheel located underneath the front part of the board for supporting the board in rolling movement over a surface;
the main wheel being located generally centrally of the board such that the rider can balance the board on the single main wheel while moving over the surface;
and an additional wheel on the rear part for movement of the rear part over the surface when separated from the front part.
